(19) United States
(12) Patent Application Publication
(10) Pub. No.: US 2018/0201048 A1
(43) Pub. Date: Jul. 19, 2018

(54) CHALK STICK HOLDER AND METHOD OF USE

(71) Applicant: Christopher J. Whigham, Lenexa, KS (US)

(72) Inventor: Christopher J. Whigham, Lenexa, KS (US)

(21) Appl. No.: 15/872,621

(22) Filed: Jan. 16, 2018

Related U.S. Application Data
(60) Provisional application No. 62/446,653, filed on Jan. 16, 2017.

(51) Int. Cl. B43K 23/016

(52) U.S. Cl. CPC B43K 23/016

(57) ABSTRACT

A chalk stick holder device having a handle portion, a hollow central tube portion, and a gripper portion. The three portions can be joined together to form a long-reaching chalk stick holder for drawing on surfaces while the user remains standing. The gripper portion includes a spring-action receiver for receiving a chalk stick and securing the chalk stick within the gripper end using a locking tooth. Upon pressing the locking tooth, the receiver releases the chalk stick, which can then be replaced with another color of chalk stick stored in the hollow central tube portion.

### CROSS-REFERENCE TO RELATED APPLICATION

This application claims priority in U.S. Provisional Patent Application No. 62/446,653 Filed Jan. 16, 2017, which is incorporated herein by reference.

### BACKGROUND OF THE INVENTION

### 1. Field of the Invention

The present invention relates generally to a chalk stick holder and method for use thereof, and more specifically to a multi-part chalk stick holder tool with handle, extension rod and chalk holder, and gripping end.

### 2. Description of the Related Art

Children enjoy drawing on surfaces, such as sidewalks and driveways, with colored chalk sticks. The problem with these sticks are that they can get lost and damaged when not in use, and can leave a chalk residue on the child's hands during use. Further, often the child will want to play with their parent or another adult while using the chalk, but often older adults have problems kneeling or bending to reach the coloring surface such as the sidewalk or driveway.

Heretofore there has not been available a system or method for a chalk stick holder with the advantages and features of the present invention.

### BRIEF SUMMARY OF THE INVENTION

The present invention generally provides a chalk stick holder device having a handle portion, a hollow central tube portion, and a gripper portion. The three portions can be joined together to form a long-reaching chalk stick holder for drawing on surfaces while the user remains standing. The gripper portion includes a spring-action receiver for receiving a chalk stick and securing the chalk stick within the gripper end using a locking tooth. Upon pressing the locking tooth, the receiver releases the chalk stick, which can then be replaced with another color of chalk stick stored in the hollow central tube portion.

### BRIEF DESCRIPTION OF THE DRAWINGS

The drawings constitute a part of this specification and include exemplary embodiments of the present invention illustrating various objects and features thereof.

FIG. 1 is a three-dimensional isometric view of a preferred embodiment of the present invention.

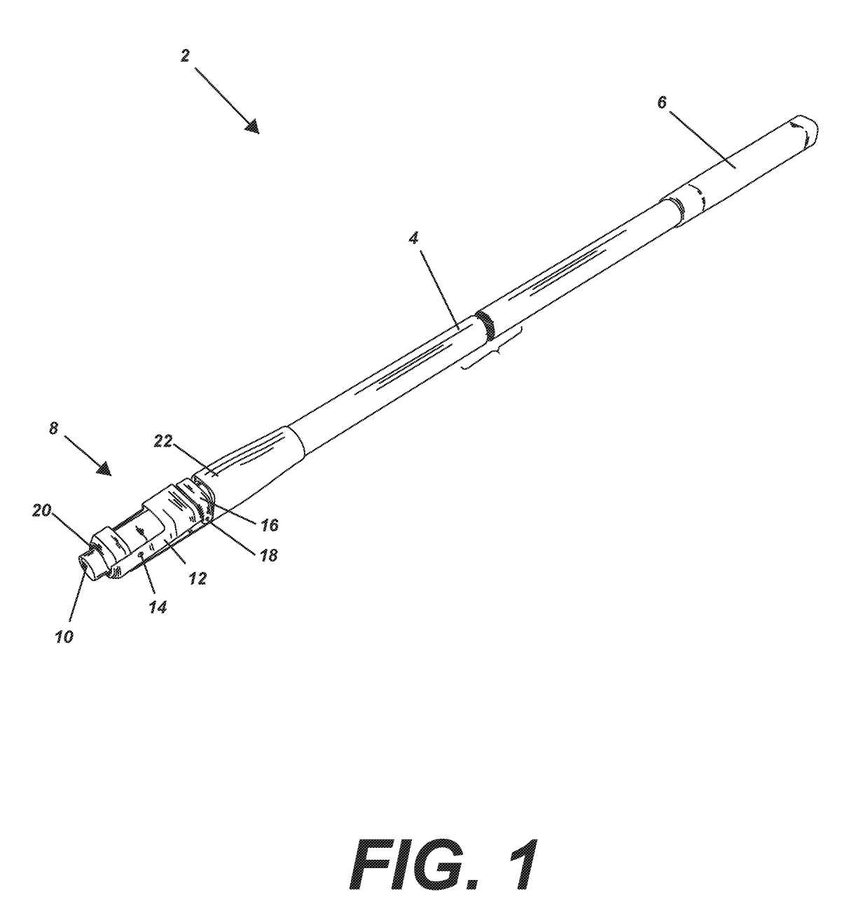

FIG. 2 is a top plan view thereof.

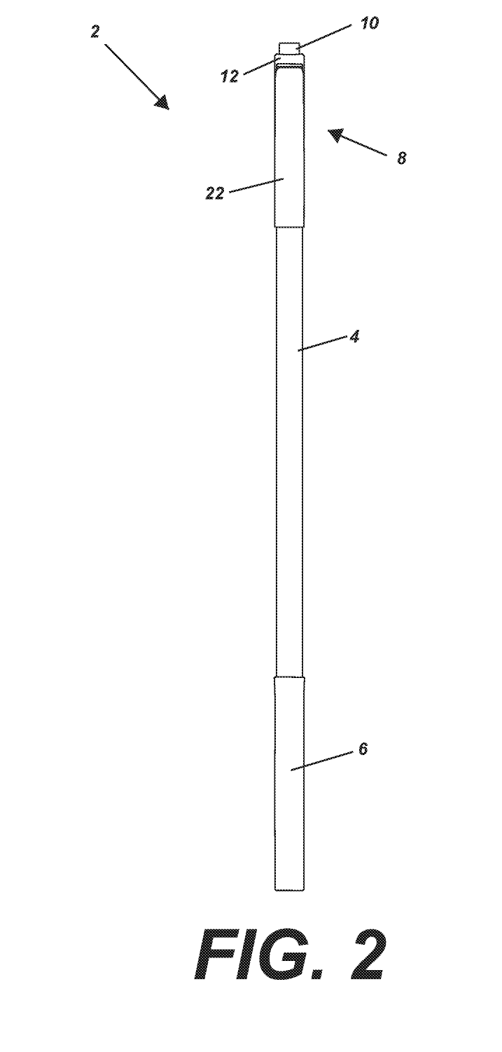

FIG. 3 is a bottom plan view thereof.

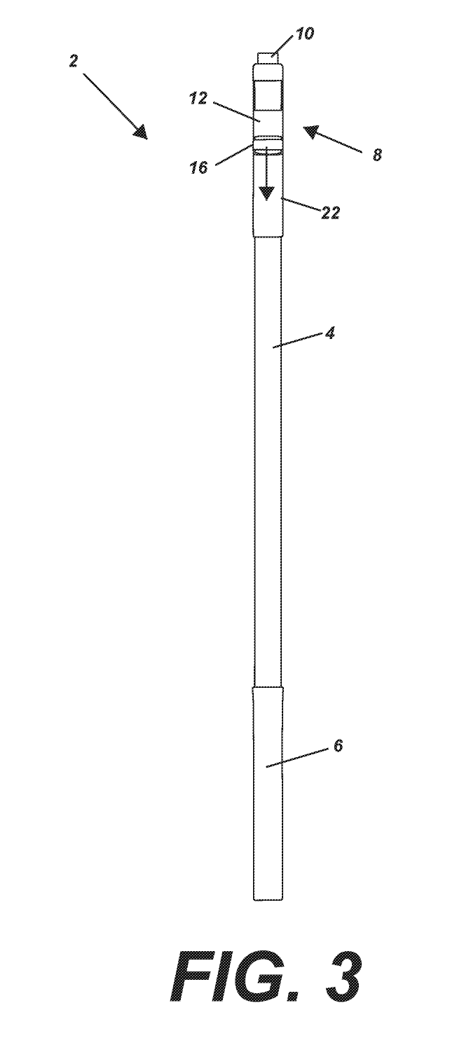

FIG. 4 is a left side elevational view thereof.

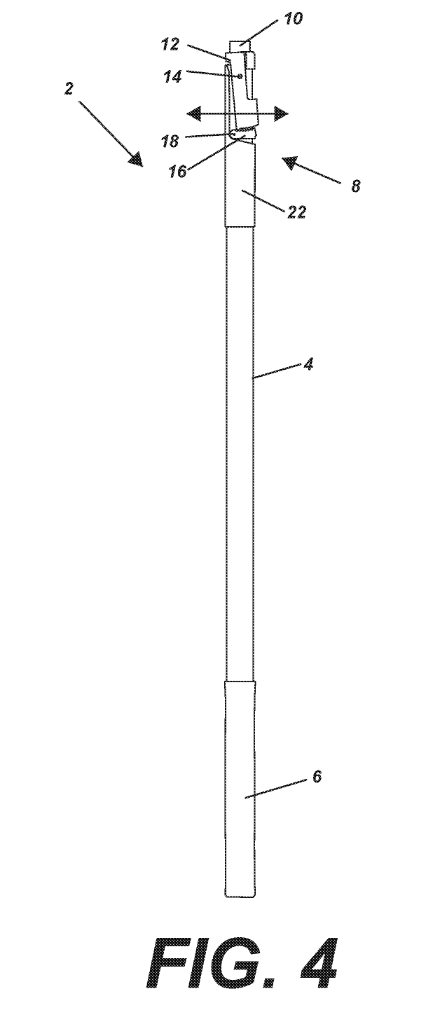

FIG. 5 is a right side elevational view thereof.

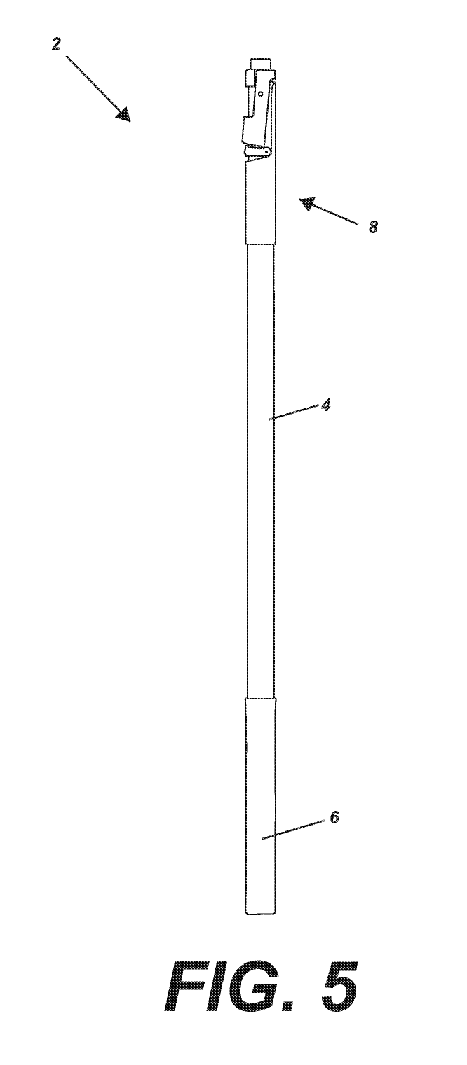

FIG. 6 is a front elevational view thereof.

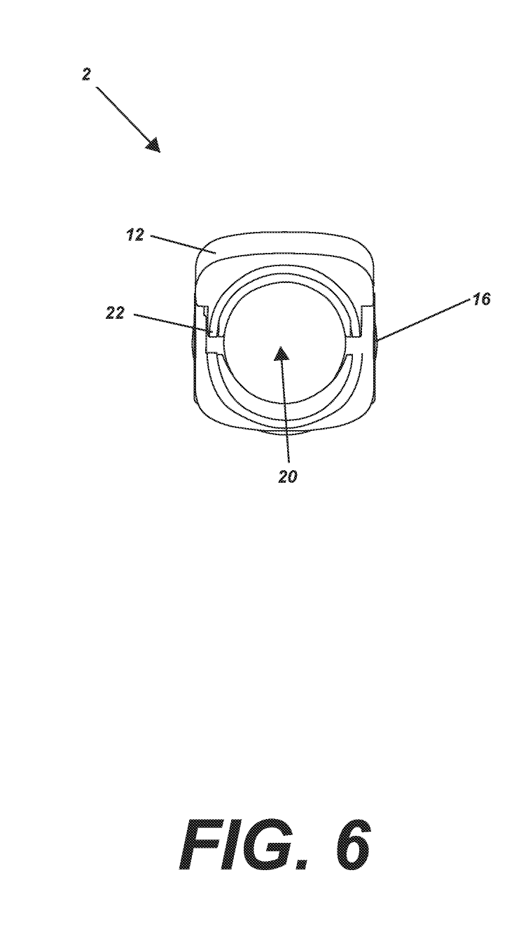

FIG. 7 is a rear elevational view thereof.

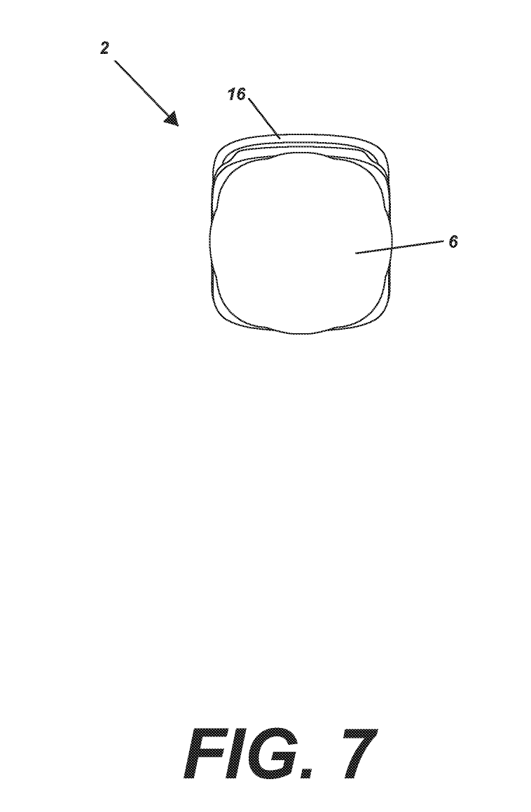

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Embodiment Chalk Stick Holder 2

As shown in the figures, a preferred embodiment of the present invention chalk stick holder 2 generally includes three parts: a handle end piece 6 for gripping, a hollow central tube 4 for storing unused chalks sticks (not shown), and a gripper end 8 for gripping one chalk stick 10. The hollow central tube 4 joins the handle end 6 and the gripper end 8 to form one long, single device as shown in the figures; however, the three pieces can be separated at will at any time.

The gripper end 8 includes a claw-like receiver 22 for allowing a chalk stick to be inserted into an opening 20 in that end, and then kept in place by the receiver using a spring action clip 12 which pivots about a spring hinge 14. The release lever 16 has several teeth 24 for securing the receiver clip 12 in place about the chalk stick 10 or to relieve the chalk stick from the receiver. The front end of the spring action clip 12 clamps against the chalk stick 10 and is held there by the release leaver 16, allowing the chalk stick 10 to be extended as it is worn down. The release lever 16 is pinned to the receiver 22 with a pin 18.

The gripper end 8 could be used as a stand-alone drawing device by itself to prevent chalk dust from staining the hands of the user, or could be used on the end of the hollow central tube and the handle end as a long-reach means of using the chalk stick. This would prevent adults or others who have physical ailments, such as back or knee problems, from bending or kneeling on the ground to draw using the chalk stick.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A chalk stick holder device comprising:
a receiver having an opening in a proximal end of said receiver, said opening configured for receiving a chalk stick;
said receiver having a hollow body for holding said chalk stick within;
a spring clip affixed to said receiver via a spring hinge, said spring clip having a front end configured to be raised to an engaged position wherein it locks said chalk stick within said receiver, and wherein said spring clip further configured to be lowered to a released position wherein said chalk stick is unlocked within said receiver;
a locking tab comprising a plurality of teeth, said locking tab configured to lock said spring clip into said engaged position by receiving said spring clip within one of said plurality of teeth;
said locking tab further configured to be drawn toward a distal end of said receiver, thereby allowing said spring clip to be lowered to said released position; and
said locking tab affixed to said receiver via a pin hinge.

2. The chalk stick holder device of claim 1, further comprising:
a hollow tube body having a proximal end and a distal end;
said proximal end of said hollow tube body removable engaging said distal end of said receiver; and
said hollow tube body configured for extending the reach of the chalk stick holder device.

3. The chalk stick holder device of claim 2, wherein said hollow tube body is configured to receive and store at least one additional chalk stick.

4. The chalk stick holder device of claim 2, further comprising:
a handle element affixed to said distal end of said hollow tube body; and
said handle element providing a grippable surface.

5. A chalk stick holder device comprising:
a receiver having an opening in a proximal end of said receiver, said opening configured for receiving a chalk stick;
said receiver having a hollow body for holding said chalk stick within;
a spring clip affixed to said receiver via a spring hinge, said spring clip having a front end configured to be raised to an engaged position wherein it locks said chalk stick within said receiver, and wherein said spring clip further configured to be lowered to a released position wherein said chalk stick is unlocked within said receiver;
a locking tab comprising a plurality of teeth, said locking tab configured to lock said spring clip into said engaged position by receiving said spring clip within one of said plurality of teeth;
said locking tab further configured to be drawn toward a distal end of said receiver, thereby allowing said spring clip to be lowered to said released position;
said locking tab affixed to said receiver via a pin hinge;
a hollow tube body having a proximal end and a distal end;
said proximal end of said hollow tube body removable engaging said distal end of said receiver;
said hollow tube body configured for extending the reach of the chalk stick holder device;
said hollow tube body is configured to receive and store at least one additional chalk stick;
a handle element affixed to said distal end of said hollow tube body; and
said handle element providing a grippable surface.

6. A method of using a chalk stick holder, the method comprising the steps:
depressing a spring clip element, said spring clip element affixed to a receiver via a spring hinge;
inserting a chalk stick into an opening within a proximal end of said receiver;
releasing said spring clip element, thereby engaging said spring clip element with said chalk stick, holding said chalk stick in place;
simultaneously engaging said spring clip element with a locking tab comprising a plurality of teeth, wherein one of said plurality of teeth engage said spring clip element;
sliding said locking tab toward a distal end of said receiver, thereby disengaging said spring clip element with said locking tab;
depressing said spring clip element; and
sliding said chalk stick within said receiver.

7. The method of claim 6, further comprising the steps:
engaging a hollow tube body with said distal end of said receiver; and
deploying at least one additional chalk stick within said hollow tube body.

8. The method of claim 7, further comprising the steps:
removing said at least one additional chalk stick from said hollow tube body; and
inserting said additional chalk stick within said receiver opening.

9. The method of claim 7, wherein said hollow tube body terminates into a handle element.
